(19) United States
(12) Patent Application Publication
(10) Pub. No.: US 2022/0398497 A1
(43) Pub. Date: Dec. 15, 2022

(54) CONTROL APPARATUS, CONTROL SYSTEM, CONTROL METHOD AND PROGRAM

(71) Applicant: NIPPON TELEGRAPH AND TELEPHONE CORPORATION, Tokyo (JP)

(72) Inventors: Hitoshi SHIMIZU, Tokyo (JP); Tomoharu IWATA, Tokyo (JP)

(73) Assignee: NIPPON TELEGRAPH AND TELEPHONE CORPORATION, Tokyo (JP)

(21) Appl. No.: 17/774,098

(22) PCT Filed: Nov. 6, 2019
(86) PCT No.: PCT/JP2019/043537

§ 371 Date: May 3, 2022

(51) Int. Cl. G06N 20/00

(52) U.S. Cl. CPC G06N 20/00; G08G 1/005

(57) ABSTRACT

A control device according to one embodiment includes control means that selects an action at for controlling a people flow in accordance with a measure π at each control step “t” of an agent in A2C by using a state st obtained by observation of a traffic condition about the people flow in a simulator and learning means that learns a parameter of a neural network which realizes an advantage function expressed by an action value function representing a value of selection of the action at in the state st under the measure π and by a state value function representing a value of the state st under the measure π.

### TECHNICAL FIELD

The present invention relates to a control device, a control system, a control method, and a program.

### BACKGROUND ART

In fields of traffic and people flow, it has been a traditional practice to determine an optimal control measure for moving bodies (for example, vehicles, persons, or the like) in a simulator by using a procedure of machine learning. For example, there has been a known technique with which a parameter can be obtained for performing optimal people-flow guidance in a people-flow simulator (for example, see Patent Literature 1). Further, for example, there has been a known technique has been known with which a parameter can be obtained for performing optimal traffic signal control in a traffic simulator (for example, see Patent Literature 2). Further, there has been a technique with which an optimal control measure can be determined for traffic signals, vehicles, and so forth in accordance with a traffic condition in a simulator by a procedure of reinforcement learning (for example, see Patent Literature 3).

### CITATION LIST

### Patent Literatures

Patent Literature 1: Japanese Laid-Open No. 2018-147075

Patent Literature 2: Japanese Laid-Open No. 2019-82934

Patent Literature 3: Japanese Laid-Open No. 2019-82809

### SUMMARY OF THE INVENTION

### Technical Problem

For example, although techniques disclosed in Patent Literatures 1 and 2 are effective in a case where a traffic condition is given, the techniques cannot be applied to a case where the traffic condition is unknown. Further, for example, in the technique disclosed in Patent Literature 3, a model and a reward in determining a control measure by reinforcement learning are not appropriate for a people flow, and there have been cases where precision of a control measure for a people flow is low.

An object of an embodiment of the present invention, which has been made in consideration of the above situation, is to obtain an optimal control measure for a people flow in accordance with a traffic condition.

### Means for Solving the Problem

To achieve the above object, a control device according to the present embodiment includes: control means that selects an action aₜ for controlling a people flow in accordance with a measure π at each control step “t” of an agent in A2C by using a state sₜ obtained by observation of a traffic condition about the people flow in a simulator; and learning means that learns a parameter of a neural network which realizes an advantage function expressed by an action value function representing a value of selection of the action aₜ in the state sₜ under the measure π and by a state value function representing a value of the state sₜ under the measure π.

### Effects of the Invention

An optimal control measure for a people flow can be obtained in accordance with a traffic condition.

### BRIEF DESCRIPTION OF DRAWINGS

FIG. 1 is a diagram illustrating one example of a general configuration of a control system according to the present embodiment.

FIG. 2 is a diagram illustrating one example of a hardware configuration of a control device according to the present embodiment.

FIG. 3 is a diagram illustrating one example of a neural network which realizes an action value function and a state value function according to the present embodiment.

FIG. 4 is a flowchart illustrating one example of a learning process according to the present embodiment.

FIG. 5 is a diagram for explaining one example of the relationship between a simulator and learning.

FIG. 6 is a flowchart illustrating one example of a simulation process according to the present embodiment.

FIG. 7 is a flowchart illustrating one example of a control process in the simulator according to the present embodiment.

FIG. 8 is a flowchart illustrating one example of an actual control process according to the present embodiment.

FIG. 9 is a diagram illustrating one example of changes in total rewards.

FIG. 10 is a diagram illustrating one example of changes in traveling times.

FIG. 11 is a diagram illustrating one example of relationships between the number of moving bodies and the traveling time.

### DESCRIPTION OF EMBODIMENTS

An embodiment of the present invention will hereinafter be described. In the present embodiment, a description will be made about a control system 1 including a control device 10 that is capable of obtaining an optimal control measure corresponding to a traffic condition in actual control (in other words, in actual control in an actual environment) by learning control measures in various traffic conditions in a simulator by reinforcement learning while having a people flow as a target.

Here, a control measure denotes means for controlling a people flow, for example, such as regulation of passage through a portion of roads among paths to an entrance of a destination and opening and closing of an entrance to a destination. Further, an optimal control measure denotes a control measure that optimizes a predetermined evaluation value for evaluating people-flow guidance (for example, such as traveling times to an entrance of a destination or the number of persons on each road). Note that in the following, each person configuring a people flow will be referred to as moving body. However, the moving body is not limited to a person, but an optional target can be set as the moving body as long as the target moves similarly to a person.

<General Configuration>

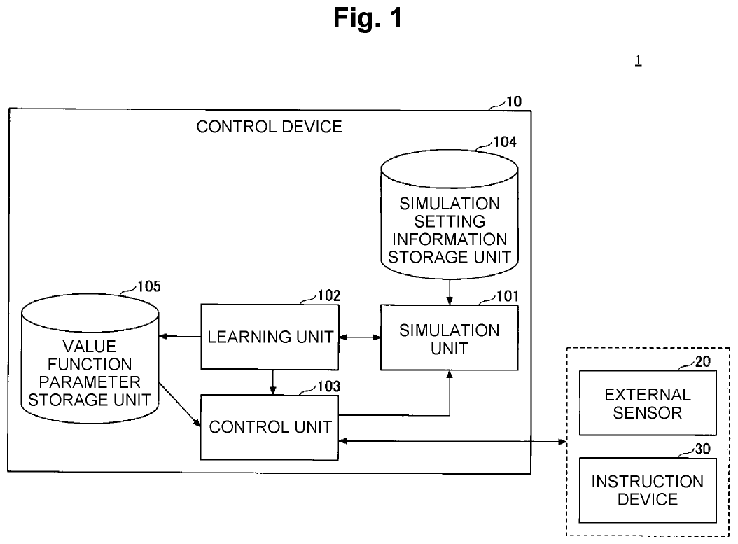

First, a general configuration of the control system 1 according to the present embodiment will be described with reference to FIG. 1. FIG. 1 is a diagram illustrating one example of the general configuration of the control system 1 according to the present embodiment.

As illustrated in FIG. 1, the control system 1 according to the present embodiment includes the control device 10, one or more external sensors 20, and an instruction device 30. Further, the control device 10, each of the external sensors 20, and the instruction device 30 are connected together to be capable of communication via an optional communication network.

The external sensor 20 is sensing equipment which is placed on a road or the like, senses an actual traffic condition, and thereby generates sensor information. Note that as the sensor information, for example, image information obtained by photographing a road or the like may be raised.

The instruction device 30 is a device which performs an instruction about passage regulation or the like for controlling a people flow based on control information from the control device 10. As such an instruction, for example, an instruction to regulate passage through a specific road among paths to an entrance of a destination, an instruction to open and close a portion of entrances of a destination, and so forth may be raised. Note that the instruction device 30 may perform the instruction for a terminal or the like possessed by a person performing traffic control, opening and closing of an entrance, or the like or may perform the instruction for a device or the like controlling a traffic signal or opening and closing of an entrance.

The control device 10 learns control measures in various traffic conditions in the simulator by reinforcement learning before actual control. Further, in the actual control, the control device 10 selects a control measure in accordance with the traffic condition corresponding to the sensor information acquired from the external sensor 20 and transmits the control information based on this selected control measure to the instruction device 30. Accordingly, the people flow is controlled in the actual control.

Here, in the present embodiment, objects are to learn a function outputting the control measure (this function will be referred to as measure π) in learning while setting a traffic condition in a simulator as a state “s” observed by an agent and setting a control measure as an action “a” selected and executed by the agent and to select the control measure corresponding to the traffic condition by a learned measure π in the actual control. Further, in order to learn an optimal control measure for the people flow, in the present embodiment, A2C (advantage actor-critic) as one of deep reinforcement learning algorithms is used, and as a reward “r”, a value is used which results from the number of moving bodies on the roads normalized by the number of moving bodies in a case where the control measure is not selected or executed.

Incidentally, an optimal measure π* that outputs the optimal control measure among various measures π denotes a measure that maximizes the expected value of a cumulative reward to be obtained from the present time to the future. This optimal measure π* can be expressed by a function that outputs an action maximizing the expected value of the cumulative reward among value functions expressing the expected value of the cumulative reward to be obtained from the present time to the future. Further, it has been known that a value function can be approximated by a neural network.

Accordingly, in the present embodiment, it is assumed that a parameter of a value function (in other words, a parameter of a neural network approximating the value function) is learned in the simulator and the optimal measure π* outputting the optimal control measure is thereby obtained.

Thus, the control device 10 according to the present embodiment has a simulation unit 101, a learning unit 102, a control unit 103, a simulation setting information storage unit 104, and a value function parameter storage unit 105.

The simulation setting information storage unit 104 stores simulation setting information. The simulation setting information denotes setting information necessary for the simulation unit 101 to perform a simulation (people-flow simulation). The simulation setting information includes information indicating a road network made up of links representing roads and nodes representing intersections, branch points, and so forth, the total number of moving bodies, a departure place and a destination of each of the moving bodies, an appearance time point of each of the moving bodies, a maximum speed of each of the moving bodies, and so forth.

The value function parameter storage unit 105 stores value function parameters. Here, as the value functions, an action value function Q^{π}(s, a) and a state value function V^{π}(s) are present. The value function parameter storage unit 105 stores a parameter of the action value function Q^{π}(s, a) and a parameter of the state value function V^{π}(s) as the value function parameters. The parameter of the action value function Q^{π}(s, a) denotes a parameter of a neural network which realizes the action value function Q^{π}(s, a). Similarly, the parameter of the state value function V^{π}(s) denotes a parameter of a neural network which realizes the state value function V^{π}(s). Note that the action value function Q^{π}(s, a) represents a value of selection of the action “a” in the state “s” under the measure π. Meanwhile, the state value function V^{π}(s) represents a value of the state “s” under the measure π.

The simulation unit 101 executes a simulation (people-flow simulation) by using the simulation setting information stored in the simulation setting information storage unit 104.

The learning unit 102 learns the value function parameter stored in the value function parameter storage unit 105 by using simulation results by the simulation unit 101.

In learning, the control unit 103 selects and executes the action “a” (in other words, the control measure) corresponding to the traffic condition in the simulator. In this case, the control unit 103 selects and executes the action “a” in accordance with the measure π represented by the value functions in which the value function parameters, learning of which is not completed, are set.

Further, in the actual control, the control unit 103 selects and executes the action “a” corresponding to the traffic condition of an actual environment. In this case, the control unit 103 selects and executes the action “a” in accordance with the measure π represented by the value functions in which the learned value function parameters are set.

Note that the general configuration of the control system 1, which is illustrated in FIG. 1, is one example, and another configuration may be used. For example, the control device 10 in learning and the control device 10 in the actual control may be realized by different devices. Further, plural instruction devices 30 may be included in the control system 1.

<Hardware Configuration>

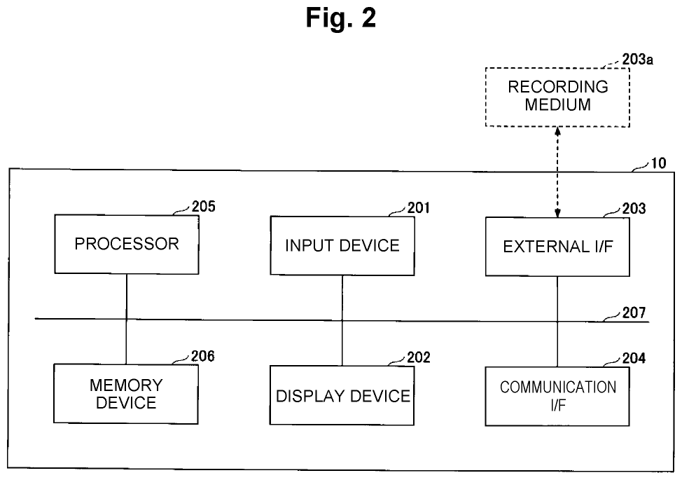

Next, a hardware configuration of the control device 10 according to the present embodiment will be described with reference to FIG. 2. FIG. 2 is a diagram illustrating one example of the hardware configuration of the control device 10 according to the present embodiment.

As illustrated in. FIG. 2, the control device 10 according to the present embodiment includes an input device 201, a display device 202, an external I/F 203, a communication I/F 204, a processor 205, and a memory device 206. Those pieces of hardware are connected together to be capable of communication via a bus 207.

The input device 201 is a keyboard, a mouse, a touch panel, or the like, for example. The display device 202 is a display or the like, for example. Note that the control device 10 may not have to have at least one of the input device 201 and the display device 202.

The external I/F 203 is an interface with external devices. The external devices may include a recording medium 203a and so forth. The control device 10 can performs reading, writing, and so forth with the recording medium 203a via the external I/F 203. The recording medium 203a may store one or more programs which realize function units (such as the simulation unit 101, the learning unit 102, and the control unit 103) provided to the control device 10, for example.

Note that examples of the recording medium 203a may include a CD (compact disc), a DVD (digital versatile disk), an SD memory card (secure digital memory card), a USB (universal serial bus) memory card, and so forth.

The communication I/F 204 is an interface for connecting the control device 10 with a communication network. The control device 10 can acquire the sensor information from the external sensor 20 and transmit the control information to the instruction device 30 via the communication I/F 204. Note that one or more programs which realize function units provided to the control device 10 may be acquired (downloaded) from a predetermined server device or the like via the communication I/F 204.

The processor 205 is each kind of arithmetic device such as a CPU (central processing unit) or a GPU (graphics processing unit), for example. The function units provided to the control device 10 are realized by processes that one or more programs stored in the memory device 206 or the like causes the processor 205 to execute.

Examples of the memory device 206 may include various kinds of storage devices such as an HDD (hard disk drive), an SSD (solid state drive), a RAM (random access memory), a ROM (read only memory), and a flash memory. The simulation setting information storage unit 104 and the value function parameter storage unit 105 can be realized by using the memory device 206, for example. Note that the simulation setting information storage unit 104 and the value function parameter storage unit 105 may be realized by a storage device, a database server, or the like which is connected with the control device 10 via the communication network.

The control device 10 according to the present embodiment has the hardware configuration illustrated in FIG. 2 and can thereby realize a learning process and an actual control process, which are described later. Note that the hardware configuration illustrated in FIG. 2 is one example, and the control device 10 may have another hardware configuration. For example, the control device 10 may have plural processors 205 or may have plural memory devices 206.

<Setting of Practical Example>

Here, one practical example of the present embodiment is set.

<<Setting of Simulation>>

In the present embodiment, a simulation environment is set based on the simulation setting information as follows such that the simulation environment complies with an actual environment in which the people flow is controlled.

First, it is assumed that the road network is made up of 314 roads. Further, it is assumed that six departure places (for example, exits of a station or the like) and one destination (for example, an event site or the like) of the moving bodies are present and each of the moving bodies starts movement from any preset departure place among the six departure places toward the destination at a preset simulation time point (appearance time point). In this case, it is assumed that each of the moving bodies moves from a present place to an entrance of the destination by a shortest path at a speed which is calculated every simulation time point and in accordance with the traffic condition. In the following, the simulation time point is denoted by τ=0, 1, τ′. Note that a character τ′ denotes a finishing time point of the simulation.

Further, it is assumed that at the destination, six entrances (gates) for entering this destination are present and at least five or more gates are open. Furthermore, in the present embodiment, it is assumed that opening and closing of those gates are controlled by an agent at each preset interval Δ and the people flow are thereby controlled (in other words, the control measure represents an opening-closing pattern of the six gates). In the following, a cycle in which the agent controls opening and closing of the gates (which is a control step and will also simply be referred to as “step” in the following) is denoted by “t”. Further, in the following, it is assumed that the agent controls opening and closing of the gates at τ=0, Δ, 2×Δ, . . . , T×Δ (however, a character T denotes the greatest natural number which satisfies T×Δ≥τ′), and τ=0, Δ, 2×Δ, . . . , T×Δ are respectively expressed as t=0, 1, 2, . . . , T.

Note that because it is assumed that the six gates are present and at least five or more gates are open, seven opening-closing patterns of the gates are present.

<<Various Kinds of Settings in Reinforcement Learning>>

In the present embodiment, the state “s”, the reward “r”, various kinds of functions, and so forth in the reinforcement learning are set as follows.

First, it is assumed that a state sₜ at step “t” denotes the numbers of moving bodies present on the respective roads in four past steps. Consequently, the state sₜ is represented by data with 314×4 dimensions.

Further, a reward rₜ at step “t” is determined for the purpose of minimization of the sum of traveling times (in other words, movement times from the departure places to the entrances of the destination) of all of the moving bodies. Accordingly, a range of possible values of the reward “r” is set as [−1, 1], and the reward rₜ at step “t” is set as the following expression (1).

$$\begin{matrix}[ Math . 1 ] & \\ {r}_{t} = max ( - 1 , \frac{{N}_{open} ( t ) - {N}_{s} ( t )}{{N}_{open} ( t )} ) & ( 1 )\end{matrix}$$

However, in a case of Nₒₚₑₙ(t)=0 and Nₛ(t)>0, rₜ=−1 is set, and in a case of Nₒₚₑₙ(t)=0 and Nₛ(t)=0, rₜ=0 is set.

Here, in a case where all of the gates are always open, Nₒₚₑₙ(t) denotes the sum of the numbers of moving bodies present on the respective roads at step “t”. Further, Nₛ(t) denotes the sum of the numbers of moving bodies present on the respective roads at step “t”.

Note that (Nₒₚₑₙ(t)−Nₛ(t))/Nₒₚₑₙ(t) in the above expression (1) denotes the result of normalization of the sum of the numbers of moving bodies which are present on the respective roads at step “t” by the sum of the numbers of moving bodies which are present on the respective roads in a case where the control measure is not selected or executed and all of the gates are always open.

Further, an advantage function used for A2C is defined as the difference between the action value function Q^{π} and the state value function V^{π}. In addition, in order to avoid calculation of both of the action value function. Q^{π} and the state value function V^{π}, as the action value function Q^{π}, the sum of discounted rewards and a discounted state function V^{π} is used. That is, an advantage function A^{π} is set as the following expression (2) .

$$\begin{matrix}[ Math . 2 ] & \\ {A}^{π} ( s ) = \{ {\sum }_{i = 0}^{k - 1} {γ}^{i} {r}_{t + 1} + {γ}^{k} {V}^{π} ( {s}_{t + k} ) \} - {V}^{π} ( {s}_{t} ) & ( 2 )\end{matrix}$$

Here, a character k denotes an advanced step. Note that the part of the above expression (2) in the curly brackets denotes the sum of the discounted rewards and the state function V^{π} and corresponds to the action value function Q^{π}.

Estimated values A^{π}(s) of the advantage function are together updated to k steps ahead by the above expression (2).

Further, a loss function for learning (updating) the parameter of the neural network which realizes the value functions is set as the following expression (3).

$$\begin{matrix}[ Math . 3 ] & \\ {\{ {Q}^{π} ( s , a ) - {V}^{π} ( s ) \}}^{2} - E [ log {π}_{θ} ( s \vert a ) {A}^{π} ( s ) ] - {\sum }_{a ∈ A} \{ {π}_{θ} ( s , a ) log {π}_{θ} ( s , a ) \} & ( 3 )\end{matrix}$$

Here, a character π_{θ} denotes a measure in a case where the parameter of the neural network which realizes the value functions is θ. Further, a character E of the second term of the above expression (3) denotes an expected value about an action. Note that the first term of the above expression (3) denotes a loss function for matching value functions of actor and critic in A2C (in other words, for matching the action value function Q^{π} and the state value function V^{π}), and the second term denotes a loss function for maximizing the advantage function A^{π}. Further, the third term denotes a term in consideration of randomness at as early stage of learning (introduction of this term enables a circumstance of falling into a local solution to be avoided).

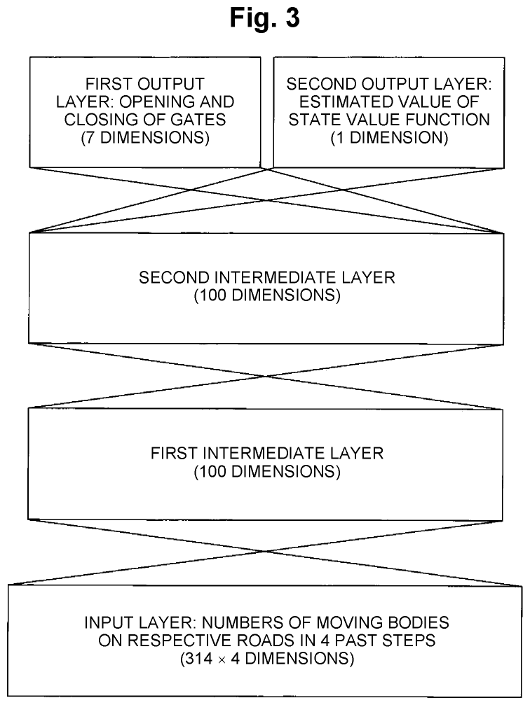

Further, it is assumed that the neural network which realizes the action value function Q^{π} and the state value function V^{π} is the neural network illustrated in FIG. 3. That is, it is assumed that the action value function Q^{π} and the state value function V^{π} are realized by a neural network made up of an input layer to which the state “s” with 314×4 dimensions is input, a first intermediate layer with 100 dimensions, a second intermediate layer with 100 dimensions, a first output layer with 7 dimensions which outputs an opening-closing pattern of the gates, and a second output layer with 1 dimension which outputs an estimated value of the state value function V^{π}(s).

Here, the action value function Q^{π} is realized by the input layer, the first intermediate layer, the second intermediate layer, and the first output layer, and the state value function V^{π} is realized by the input layer, the first intermediate layer, the second intermediate layer, and the second output layer. In other words, the action value function Q^{π} and the state value function V^{π} are realized by a neural network whose portion is shared by those.

Note that for example, in a case where actions representing seven kinds of opening-closing patterns of the gates are respectively set as a=1 to a=7, data with seven dimensions which are output from the first output layer are (Q^{π}(s=sₜ, a=1), Q^{π}(s=sₜ, a=2), . . . , Q^{π}(s=sₜ, a=7)).

<Learning Process>

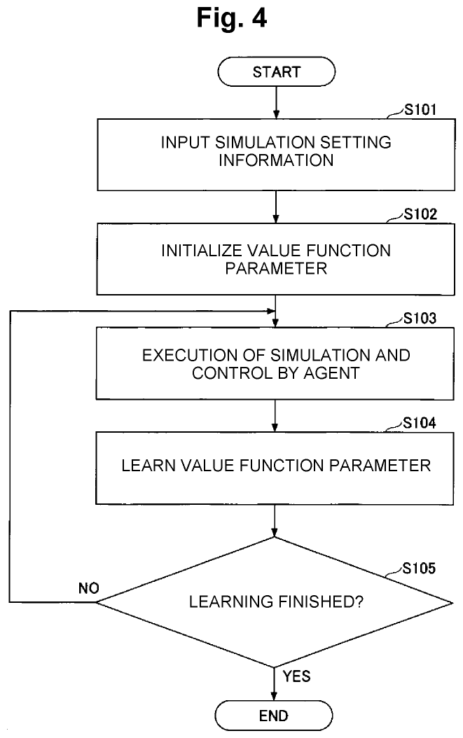

Next, a description will be made about a learning process for learning a value function parameter θ in the simulator with reference to FIG. 4. FIG. 4 is a flowchart illustrating one example of the learning process according to the present embodiment.

First, the simulation unit 101 inputs the simulation setting information stored in the simulation setting information storage unit 104 (step S101). Note that the simulation setting information is in advance created by a manipulation by a user or the like, for example, and is stored in the simulation setting information storage unit 104.

Next, the learning unit 102 initializes the value function parameter θ stored in the value function parameter storage unit 105 (step S102).

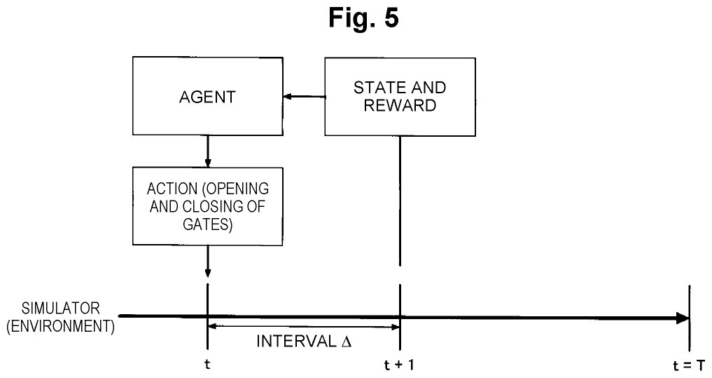

Then, the simulation unit 101 executes a simulation from the simulation time point τ=0 to τ=τ′ by using the simulation setting information stored in the simulation setting information storage unit 104, and the control unit 103 selects and executes the action “a” (in other words, the control measure) corresponding to the traffic condition in the simulator at each step “t” (step S103). Here, as illustrated in FIG. 5, at each step “t”, the control unit 103 selects and executes an action aₜ at the step “t” by the agent, observes a state sₜ₊₁ at step t+1, and calculates a reward rₜ₊₁. A description will later be made about details of a simulation process to be executed by the simulation unit 101 and a control process to be executed by the control unit 103 in this step S103. Note that in the following, a simulation from the simulation time point τ=0 to τ=τ′ is set as one episode.

Next, the learning unit 102 learns the value function parameter θ stored in the value function parameter storage unit 105 by using simulation results (simulation results of one episode) in the above step S102 (step S104). That is, for example, the learning unit 102 calculates losses (errors) in steps “t” (in other words, t=0, 1, 2, . . . , T) of the episode by the loss function expressed by the above expression (3) and updates the value function parameter θ by backpropagation using those errors. Accordingly, A_{π} is updated (that Q^{π} and V^{π} are simultaneously updated).

Net, the learning unit 102 assesses whether or not a finishing condition of learning is satisfied (step S105). Then, in a case where it is assessed that the finishing condition is not satisfied, the learning unit 102 returns to the above step S103. Accordingly, the above step S103 to step S104 are repeatedly executed until the finishing condition is satisfied, and the value function parameter θ is learned. As the finishing condition of learning, for example, a predetermined number of repetitions of execution of the above step S103 to step S104 (in other words, a predetermined number of executions of episodes) or the like may be raised.

Note that for example, in a case where the gates are opened and closed while one episode takes 2 hours and the interval is set as 10 minutes, one episode provides 7¹² combinations of the opening-closing patterns of the gates. Thus, it is difficult to exhaustively and greedily search for the optimal combination of the opening-closing patterns in terms of time cost; however, in the present embodiment, it becomes possible to learn the value function parameter for obtaining the optimal opening-closing patterns by realistic time cost (approximately several hours to several ten hours).

<<Simulation Process>>

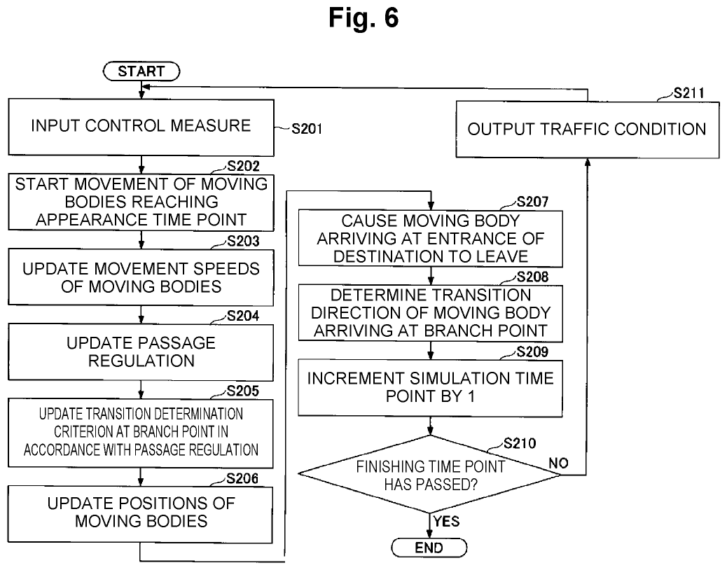

Here, a simulation process in the above step S103 will be described with reference to FIG. 6. FIG. 6 is a flowchart illustrating one example of the simulation process according to the present embodiment. Note that step S201 to step S211 in the following are repeatedly executed at each simulation time point τ. Accordingly, in the following, the simulation process at a certain simulation time point τ will be described.

First, the simulation unit 101 inputs the control measure (in other words, the opening-closing pattern of the gates) at a present simulation time point (step S201).

Next, the simulation unit 101 starts movement of the moving bodies reaching the appearance time point (step S202). Further, the simulation unit 101 updates the movement speeds of the moving bodies which have started movement in the above step S202 in accordance with the present simulation time point τ (step S203).

Next, the simulation unit 101 updates the passage regulation in accordance with the control measure input in the above step S201 (step S204). That is, the simulation unit 101 opens and closes the gates (six gates) of the destination, prohibits passage through specific roads, and enables passage through specific roads in accordance with the control measure input in the above step S201. Note that as the road passage through which is prohibited, for example, the road for moving toward the closed gate or the like may be raised. Similarly, as the road passage through which is permitted, for example, the road for moving toward the opened gate or the like may be raised.

Next, the simulation unit 101 updates a transition determination criterion at each branch point of the road network in accordance with the passage regulation updated in the above step S204 (step S205). That is, the simulation unit 101 updates the transition determination criterion such that the moving bodies do not transit to the roads passage through which is prohibited and the moving bodies are capable of transiting to the roads passage through which is permitted. Here, the transition determination criterion is a criterion for determining to which road among plural roads branching at the branch point the moving body advances in a case where the moving body reaches this branch point. This criterion may be a definitive criterion which results in branching into any one road or may be a probabilistic criterion expressed by branching probabilities to the roads as branching destinations.

Next, the simulation unit 101 updates the position (present place) of each of the moving bodies in accordance with the present place and the speed of the no body (step S206). Note that as described above, it is assumed that each of the moving bodies moves from the present place to the entrance (any one gate among the six gates) of the destination by the shortest path.

Next, the simulation unit 101 causes the moving body to leave, the moving body arriving at the entrance (any one of the gates) of the destination as a result of the update in the above step S206 (step S207).

Next, the simulation unit 101 determines a transition direction of the moving body reaching the branch point as a result of the update in the above step S206 (in other words, to which road among plural roads branching from this branch point the moving body advances) (step S208).

Next, the simulation unit 101 increments the simulation time point τ by one (step S209). Accordingly, the simulation time point τ is updated to τ+1.

Next, the simulation unit 101 assesses whether or not the finishing time point τ′ of the simulation has passed (step S210). That is, the simulation unit 101 assesses whether or not τ+1>τ′ holds. In a case where it is assessed that the finishing time point τ′ of the simulation has passed, the simulation unit 101 finishes the simulation process.

On the other hand, in a case where it is assessed that the finishing time point τ′ of the simulation has not passed, the simulation unit 101 outputs the traffic condition (in other words, the numbers of moving bodies which are respectively present on the 314 roads) to the agent (step S211).

<<Control Process in Simulator>>

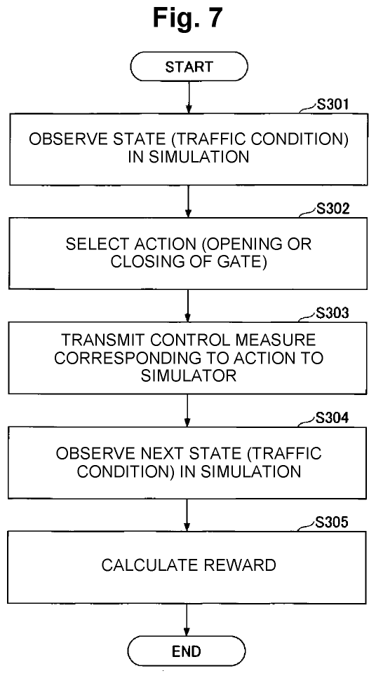

Next, a control process in the simulator in the above step S103 will be described with reference to FIG. 7. FIG. 7 is a flowchart illustrating one example of the control process in the simulator according to the present embodiment. Note that step S301 to step S305 in the following are repeatedly executed at each control step “t”. Accordingly, in the following, the control process in the simulator at a certain step “t” will be described.

First, the control unit 103 observes the state (in other words, the traffic condition in four past steps) sₜ at step “t” (step S301).

Next, the control unit 103 selects the action aₜ in accordance with a measure π_{θ} by using the state sₜ observed in the above step S301 (step S302). Note that a character θ denotes the value function parameter.

Here, for example, the control unit 103 may convert output results of the neural network which realizes the action value function Q^{π} (in other words, the neural network made up of the input layer, the first intermediate layer, the second intermediate layer, and the first output layer of the neural network illustrated in FIG. 3) to a probability distribution by a softmax function and may select the action aₜ in accordance with this probability distribution. More specifically, the control unit 103 may convert the output results of the first output layer (Q^{π}(s=sₜ, a=1), Q^{π}(s=sₜ, a=2) , . . . , Q^{π}(s=sₜ, a=7)) to a probability distribution (p^{t}₁, p^{t}₂, . . . , p^{t}₇) by the softmax function and may select the action aₜ in accordance with this probability distribution. Note that for example, in a case where actions representing seven kinds of opening-closing patterns of the gates are respectively set as aₜ=1 to aₜ=7, p^{t}₁ to p^{t}₇ are the respective probabilities of selecting aₜ=1 to aₜ=7.

Next, the control unit 103 transmits the control measure (the opening-closing pattern of the gates) corresponding to the action aₜ selected in the above step S302 to the simulation unit 101 (step S303). Note that this means that the action aₜ selected in the above step S302 is executed.

Next, the control unit 103 observes the state sₜ₊₁ at step t+1 (step S304).

Then, the control unit 103 calculates a reward rₜ₊₁ at step t+1 by the above expression (1) (step S305).

As described above, the control device 10 according to the present embodiment observes the traffic condition in the simulator and learns the value function parameter by using A2C as a reinforcement learning algorithm and by using, as the reward “r”, the value which results from the number of moving bodies on the roads normalized by the number of moving bodies in a case where the control measure is not selected or executed. Accordingly, the control device 10 according to the present embodiment can learn the optimal control measure for controlling the people flow in accordance with the traffic condition.

<Actual Control Process>

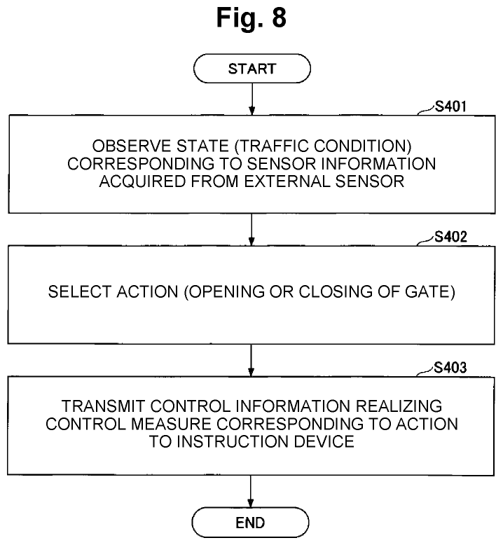

Next, a description will be made about an actual control process in which the actual control is performed by an optimal measure π_{θ}* using the value function parameter θ learned in the above learning process with reference to FIG. 8. FIG. 8 is a flowchart illustrating one example of the actual control process according to the present embodiment. Note that step S401 to step S403 in the following are repeatedly executed at each control step “t”. Accordingly, in the following, the actual control process at a certain step “t” will be described.

First, the control unit 103 observes the state sₜ corresponding to the sensor information acquired from the external sensor (in other words, the traffic condition in an actual environment in four past steps) (step S401).

Next, the control unit 103 selects the action aₜ in accordance with the measure π_{θ} by using the state sₜ observed in the above step S401 (step S402). Note that a character θ denotes the learned value function parameter.

Then, the control unit 103 transmits the control information which realizes the control measure (the opening-closing pattern of the gates) corresponding to the action aₜ selected in the above step S402 to the instruction device 30 (step S403). Accordingly, the instruction device 30 receiving the control information performs an instruction for opening and closing the gates and an instruction for performing passage regulation, and the people flow can be controlled in accordance with the traffic condition in the actual environment.

<Evaluation>

Next, evaluation of a procedure of the present embodiment will be described. In this evaluation, a comparison of the procedure of the present embodiment with other control procedures was performed by using a common PC (personal computer) under the following settings. Note that as the other control procedures, “Open all gates” and “Random greedy” were employed. Open all gates denotes a case where all of the gates are always opened (in other words, a case where all of the gates are always opened and control is not performed), and Random greedy denotes a method which performs control by changing a portion of the best measure at the present time at random and by searching for a better measure. In Random greedy, it is necessary to perform a search in each scenario and to obtain a solution (control measure). On the other hand, in the present embodiment, because a solution (control measure) is obtained by using a learned model (in other words, a value evaluation function in which a learned parameter is set), when learning is finished once, it is not necessary to perform a search in each scenario. Note that a scenario denotes a simulation environment represented by the simulation setting information.

Number of moving bodies: N=80,000

Simulation time (finishing time point τ′ of simulation: 20,000 [s]

Interval: Δ=600 [s]

Simulation setting information: preparing 8 scenarios with different people-inflow patterns

Learning rate: 0.001

Advanced steps: 34 (until completion of simulation)

Number of workers: 16

Note that it is assumed that various kinds of settings other than the above are as described in <Setting of Practical Example>. The number of workers denotes the number of agents which are capable of being in parallel executed at a certain control step. In this case, all of the actions “a” respectively selected by 16 agents and the rewards “r” in those actions are used for learning.

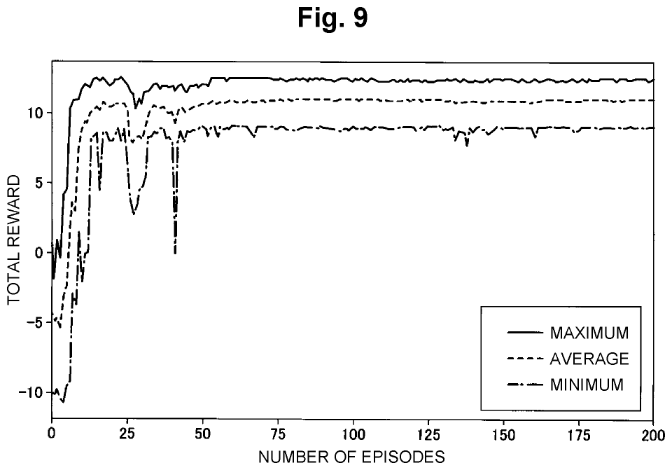

FIG. 9 illustrates changes in the maximum value, average value, and minimum value of the total reward in the procedure of the present embodiment in this case. As illustrated in FIG. 9, it may be understood that in the procedure of the present embodiment, as for all of the maximum value, average value, and minimum value, the actions are selected to obtain high rewards when the number of episodes is at seventy fifth or later episode.

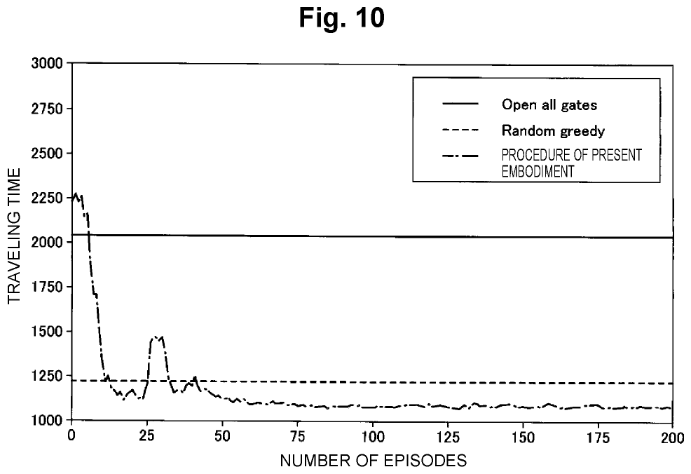

Further, FIG. 10 illustrates changes in traveling times in the procedure of the present embodiment and the other control procedures. As illustrated in FIG. 10, Random greedy improves the traveling time by a maximum of about 39.8% compared to Open all gates, and the procedure of the present embodiment improves the traveling time by a maximum of about 47.5% compared to Open all gates. Thus, it may be understood that the actions which further optimize the traveling time are selected in the procedure of the present embodiment compared to the other control procedures.

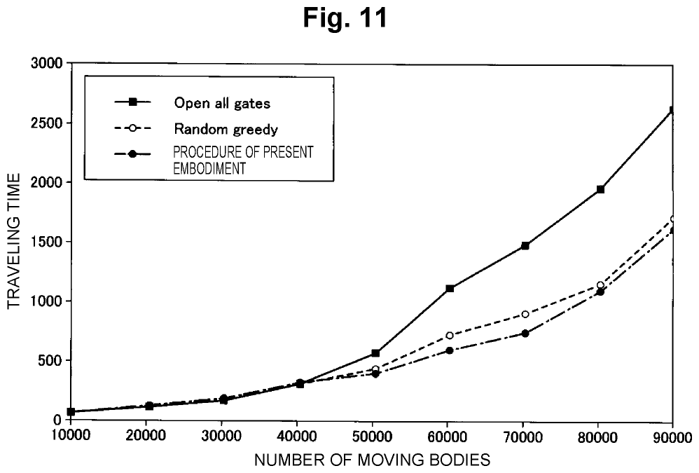

Further, FIG. 11 illustrates the relationships between the number of moving bodies and the traveling time in the procedure of the present embodiment and the other control procedures. As illustrated in FIG. 11, it may be understood that particularly in a case of N≥50,000, the procedure of the present embodiment improves the traveling time compared to the other control procedures. Further, it may be understood that in a case of N<50,000, the traveling time is almost equivalent to Open all gates because crowdedness hardly occurs.

Next, robustness of the procedure of the present embodiment and the other control procedures will be described. The following table 1 indicates traveling times in the procedures in a scenario different from the above eight scenarios.

TABLE 1

| Procedure | Traveling time [s] |
|---|---|
| Open all gates | 1.952 |
| Random greedy | 1.147 |
| Procedure of present embodiment | 1.098 |

As indicated in the above table 1, it may be understood that in the procedure of the present embodiment, the traveling time is 1,098 [s] even in the scenario different from the above eight scenarios and the procedure of the present embodiment has high robustness.

The present invention is not limited to the above embodiment disclosed in detail, and various modifications, changes, combinations with known techniques, and so forth are possible without departing from the description of claims.

### Reference Signs List

1 control system

10 control device

20 external sensor

30 instruction device

101 simulation unit

102 learning unit

103 control unit

104 simulation setting information storage unit

105 value function parameter storage unit

1. A control device comprising a processor configured to execute a method comprising:
selecting an action aₜ for controlling a people flow in accordance with a measure π at each control step “t” of an agent in advantage actor-critic (A2C) by using a state sₜ obtained by observation of a traffic condition about the people flow in a simulator; and
learning a parameter of a neural network which realizes an advantage function expressed by an action value function representing a value of selection of the action aₜ in the state sₜ under the measure π and by a state value function representing a value of the state sₜ under the measure π.

2. The control device according to claim 1,
wherein, when a value resulting from a number of moving bodies in a case where the people flow is controlled by the action aₜ normalized by the number of moving bodies in a case where the people flow is not controlled is defined as a reward rₜ₊₁, the action value function is expressed by a sum of a sum of the discounted rewards rₜ₊₁ to k steps ahead and the discounted state value function.

3. The control device according to claim 1, wherein
a loss function for learning the parameter is expressed by a sum of:
a loss function about the state value function,
a loss function about the action value function, and
a term in consideration of randomness at an early stage of the learning, and
the processor further configured to execute a method comprising:
learning the parameter by backpropagation by using a loss calculated by the loss function at each control step “t”.

4. The control device according to claim 1, the processor further configured to execute a method comprising:
selecting the action aₜ in accordance with the measure π at each control step “t” by further using sₜ obtained by observation of a traffic condition about a people flow in an actual environment and using the learnt parameter.

5. A control system comprising a processor configured to execute a method comprising:
selecting an action aₜ for controlling a people flow in accordance with a measure π at each control step “t” of an agent in advantage actor-critic (A2C) by using a state sₜ obtained by observation of a traffic condition about the people flow in a simulator; and
learning a parameter of a neural network which realizes an advantage function expressed by an action value function representing a value of selection of the action aₜ in the state sₜ under the measure π and by a state value function representing a value of the state sₜ under the measure π.

6. A computer-implemented method for controlling a people flow:
selecting an action aₜ for controlling a people flow in accordance with a measure π at each control step “t” of an agent in advantage actor-critic (A2C) by using a state sₜ obtained by observation of a traffic condition about the people flow in a simulator; and
learning a parameter of a neural network which realizes an advantage function expressed by an action value function representing a value of selection of the action aₜ in the state sₜ under the measure π and by a state value function representing a value of the state sₜ under the measure π.

7. (canceled)

8. The control device according to claim 1, wherein the state sₜ in sensor information acquired from a sensor represents the traffic condition.

9. The control device according to claim 2, wherein
a loss function for learning the parameter is expressed by a sum of:
a loss function about the state value function,
a loss function about the action value function, and
a term in consideration of randomness at an early stage of the learning, and
the processor further configured to execute a method comprising:
learning the parameter by backpropagation by using a loss calculated by the loss function at each control step “t”.

10. The control device according to claim 2, the processor further configured to execute a method comprising:
selecting the action aₜ in accordance with the measure π at each control step “t” by further using sₜ obtained by observation of a traffic condition about a people flow in an actual environment and using the learnt parameter.

11. The control device according to claim 3, the processor further configured to execute a method comprising:
selecting the action aₜ in accordance with the measure π at each control step “t” by further using sₜ obtained by observation of a traffic condition about a people flow in an actual environment and using the learnt parameter.

12. The control system according to claim 5, wherein the state sₜ in sensor information acquired from a sensor represents the traffic condition.

13. The control system according to claim 5, wherein, when a value resulting from a number of moving bodies in a case where the people flow is controlled by the action aₜ normalized by the number of moving bodies in a case where the people flow is not controlled is defined as a reward rₜ₊₁, the action value function is expressed by a sum of a sum of the discounted rewards rₜ₊₁ to k steps ahead and the discounted state value function.

14. The control system according to claim 5, wherein
a loss function for learning the parameter is expressed by a sum of:
a loss function about the state value function,
a loss function about the action value function, and
a term in consideration of randomness at an early stage of the learning, and
the processor further configured to execute a method comprising:
learning the parameter by backpropagation by using a loss calculated by the loss function at each control step “t”.

15. The control system according to claim 5, the processor further configured to execute a method comprising:
selecting the action aₜ in accordance with the measure π at each control step “t” by further using sₜ obtained by observation of a traffic condition about a people flow in an actual environment and using the learnt parameter.

16. The control system according to claim 13, wherein
a loss function for learning the parameter is expressed by a sum of:
a loss function about the state value function,
a loss function about the action value function, and
a term in consideration of randomness at an early stage of the learning, and
the processor further configured to execute a method comprising:
learning the parameter by backpropagation by using a loss calculated by the loss function at each control step “t”.

17. The control system according to claim 13, the processor further configured to execute a method comprising:
selecting the action aₜ in accordance with the measure π at each control step “t” by further using sₜ obtained by observation of a traffic condition about a people flow in an actual environment and using the learnt parameter.

18. The computer-implemented method according to claim 6, wherein the state sₜ in sensor information acquired from a sensor represents the traffic condition.

19. The computer-implemented method according to claim 6, wherein, when a value resulting from the number of moving bodies in a case where the people flow is controlled by the action aₜ normalized by a number of moving bodies in a case where the people flow is not controlled is defined as a reward rₜ₊₁, the action value function is expressed by a sum of a sum of the discounted rewards rₜ₊₁ to k steps ahead and the discounted state value function.

20. The computer-implemented method according to claim 6,
wherein
a loss function for learning the parameter is expressed by a sum of:
a loss function about the state value function,
a loss function about the action value function, and
a term in consideration of randomness at an early stage of the learning, and
the method further comprising:
learning the parameter by backpropagation by using a loss calculated by the loss function at each control step “t”.

21. The computer-implemented method according to claim 6, the method further comprising:
selecting the action aₜ in accordance with the measure π at each control step “t” by further using sₜ obtained by observation of a traffic condition about a people flow in an actual environment and using the learnt parameter.
